(19) United States
(12) Patent Application Publication
(10) Pub. No.: US 2017/0070084 A1
(43) Pub. Date: Mar. 9, 2017

(54) POWER SYSTEM, CHARGING AND DISCHARGING CONTROL DEVICE, AND CHARGING AND DISCHARGING CONTROL METHOD

(71) Applicant: Sharp Kabushiki Kaisha, Sakai-shi, Osaka (JP)

(72) Inventors: Taku MATSUMOTO, Sakai-shi (JP); Akinori ITOH, Sakai-shi (JP)

(21) Appl. No.: 15/118,636

(22) PCT Filed: Feb. 16, 2015
(86) PCT No.: PCT/JP2015/054066

§ 371 Date: Aug. 12, 2016

(30) Foreign Application Priority Data
Feb. 24, 2014 (JP) 2014-032589

(51) Int. Cl. H02J 7/35; H02J 3/38; H02J 3/46; H02J 7/00

(52) U.S. Cl. CPC H02J 7/35; H02J 7/007; H02J 3/383; H02J 3/46

(57) ABSTRACT

A power system includes: a solar cell capable of performing a reverse flow of generated power to a power grid and capable of supplying generated power to a load; a storage battery capable of being charged with power supplied from the power grid and capable of discharging the charged power to supply the discharged power to the load; and a charging and discharging control device configured to control charging and discharging of the storage battery, wherein with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and the charging and discharging control device controls, based on meteorological information, to which of the time periods a discharge starting time of the storage battery is set.

### TECHNICAL FIELD

The present invention relates to a power system, a charging and discharging control device, and a charging and discharging control method for controlling a storage battery such that power supplied from a power grid is discharged in a time period different from a time period in which the power has been charged.

### BACKGROUND ART

For example, PTL 1 has been known as a technique for charging power supplied from a power grid into a storage battery in a time period and discharging the power charged in the storage battery in another time period.

In PTL 1, it is described that consumption of power from a commercial alternating-current power source is limited during photovoltaic power generation to secure sellable power; power is bought from the commercial alternating-current power source at a night-time power rate and is charged into a storage battery to allow the power of the storage battery to be consumed during the photovoltaic power generation, and direct consumption is also performed at the night-time power rate; when the power becomes insufficient by the next night-time rate time period, the storage battery is supplementarily charged by the photovoltaic power generation or the commercial alternating-current power source; the power charged at the night-time power rate in the storage battery is shared among external storage batteries while charging of the storage battery by the photovoltaic power generation or the commercial alternating-current power source and discharging through self-consumption are monitored to determine the proportion of power in the storage battery other than the power charged at the night-time power rate; and direct power from the commercial power source and DC/AC converted power from the storage battery are supplied to an alternating-current distribution board.

### CITATION LIST

### Patent Literature

PTL 1 Japanese Unexamined Patent Application Publication No. 2011-97795

### SUMMARY OF INVENTION

### Technical Problem

As described in PTL 1, the rate structure, which for example, offers different rates in the daytime and in the nighttime has been introduced. Recently, the rate structure of electricity has been further diversified. For such a diversifying rate structure of electricity, no technique for controlling power to sufficiently reduce the power consumption rate has been proposed.

In view of the above problems, the present invention was realized, and the present invention aims to provide a power system, a charging and discharging control device, and a charging and discharging control method capable of reducing the power consumption rate when a storage battery is controlled such that power supplied from a power grid is discharged in a time period different from a time period in which the power has been charged.

### Solution to Problem

To solve the problems described above, the power system according to the present invention includes: a solar cell capable of performing a reverse flow of generated power to a power grid and capable of supplying generated power to a load; a storage battery capable of being charged with power supplied from the power grid and capable of discharging the charged power to supply the discharged power to the load; and a charging and discharging control device configured to control charging and discharging of the storage battery, wherein with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and the charging and discharging control device controls, based on meteorological information, to which of the time periods a discharge starting time of the storage battery is set.

The charging and discharging control device of the present invention is configured to control charging and discharging of a storage battery capable of being charged with power supplied from the power grid and capable of discharging the charged power to supply the discharged power to the load, wherein with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and the charging and discharging control device controls, based on meteorological information, to which of the time periods a discharge starting time of the storage battery is set.

The charging and discharging control method of the present invention includes: controlling charging and discharging of a storage battery capable of being charged with power supplied from the power grid and capable of discharging the charged power to supply the discharged power to the load, wherein with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and to which of the time periods a discharge starting time of the storage battery is set is controlled based on meteorological information.

### Advantageous Effects of Invention

According to the present invention, it is possible to reduce the power consumption rate when a storage battery is controlled such that power supplied from a power grid is discharged in a time period different from a time period in which the power has been charged.

### BRIEF DESCRIPTION OF DRAWINGS

FIG. 1 is a block diagram schematically illustrating the configuration of a power system of an embodiment.

FIG. 2 is a view illustrating control operation of a first embodiment.

FIG. 3 is a flowchart illustrating the sequence of processes performed by a charging and discharging control unit of the first embodiment.

FIG. 4 is flowchart illustrating the sequence of processes performed by a charging and discharging control unit of a second embodiment and a third embodiment.

FIG. 5 is flowchart illustrating the sequence of processes performed by a charging and discharging control unit of a fourth embodiment.

### DESCRIPTION OF EMBODIMENTS

Embodiments of the present invention will be described below with reference to the drawings.

### First Embodiment

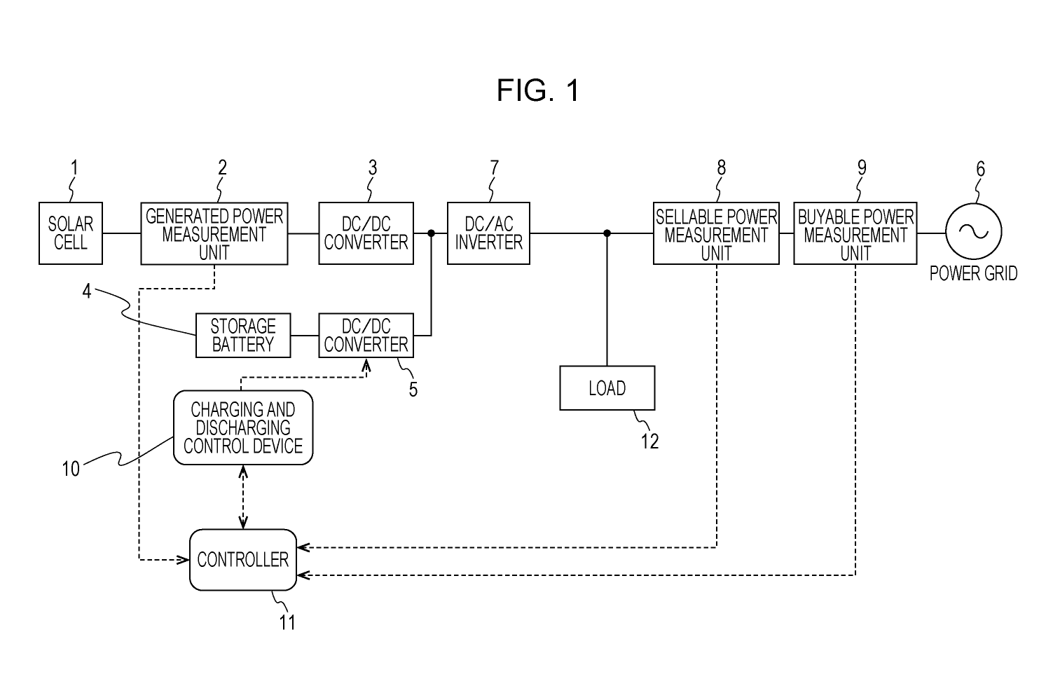

FIG. 1 is a functional block diagram schematically illustrating the configuration of a power system of a first embodiment.

The power system illustrated in FIG. 1 includes a solar cell 1, a generated power measurement unit 2 configured to measure power generated by the solar cell 1, a DC/DC converter 3 configured to convert a direct voltage from the solar cell 1, a storage battery 4, a DC/DC converter 5 configured to convert a direct voltage to obtain a converted voltage and to supply the converted voltage to the storage battery 4, and to convert a direct voltage from the storage battery 4, a bidirectional DC/AC inverter 7 configured to convert direct-current power from the DC/DC converter 3 or the DC/DC converter 5 into alternating-current power and to convert alternating-current power from a power grid 6 into direct-current power, a sellable power measurement unit 8 configured to measure sellable power by performing a reverse flow of the alternating-current power obtained by the conversion by the DC/AC inverter 7 to the power grid 6, a buyable power measurement unit 9 configured to measure power supplied from the power grid 6, a charging and discharging control unit 10 serving as a charging and discharging control device configured to control charging and discharging of the storage battery 4, and a controller 11. The configuration illustrated in FIG. 1 further includes a load 12 connected between the DC/AC inverter 7 and the sellable power measurement unit 8. The load 12 can be supplied with power from the power grid 6, power from the solar cell 1, and power from the storage battery 4.

The controller 11 includes a communication interface. Via the communication interface, the controller 11 can receive information relating to generated power from the generated power measurement unit 2, information relating to sellable power from the sellable power measurement unit 8, and information relating to buyable power from the buyable power measurement unit 9 through a wire or wirelessly, and can externally receive meteorological information via an Internet connection. Examples of the meteorological information include but are not particularly limited to weather forecast, precipitation, air temperature, humidity, wind direction, wind speed, insolation, duration of sunshine, sunrise and sunset times, weather warning, and weather advisory warning. The controller 11 can communicate with the charging and discharging control unit 10 via the communication interface by a wire or wirelessly. By controlling the charging and discharging control unit 10, it is possible to control the charging and discharging of the storage battery 4, inclusive of control of the discharge starting time of the storage battery 4.

As the controller 11, a portable terminal apparatus such as a tablet terminal device, a smartphone, and the like can be used. The controller 11 can monitor information relating to power generated by the solar cell 1, information relating to power which has reversely flowed, and information relating to power supplied from the power grid 6 based on the information from the generated power measurement unit 2, the information from the sellable power measurement unit 8, and the information from the buyable power measurement unit 9, respectively.

A rate plan for power consumption of the present embodiment will be described. In the present embodiment, during weekdays, the rate plan has three stages, namely a first time period from 23:00 to 7:00 the next morning, a second time period from 7:00 to 10:00 and from 17:00 to 23:00, and a third time period from 10:00 to 17:00. For example, a power consumption of 1 kWh costs 10 yen 76 sen in the first time period, 24 yen 59 sen in the second time period, and 32 yen 58 sen in the third time period, that is, the rate increases in the order of the first time period, the second time period, and the third time period.

### (Description of the Case of Sunny Weather)

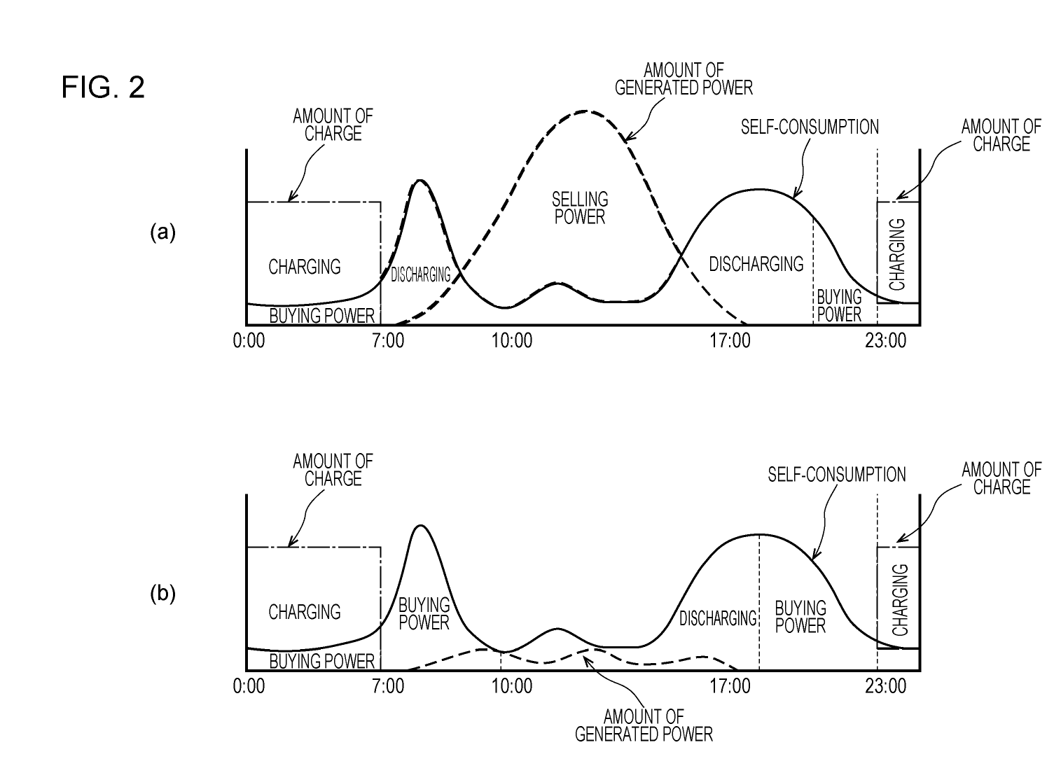

First, the operation of the present embodiment on a day on which the weather is forecast to be sunny will be described with reference to FIG. 2(a). In FIG. 2(a), (b), the abscissa denotes time, and the ordinate denotes the amount of any power, wherein the solid line, “self-consumption,” indicates the amount of power consumed by the load 12, the broken line, “amount of generated power,” indicates the amount of power generated by the solar cell 1, the dot-dash line, “amount of charge,” indicates the amount of power charged into the storage battery 4, the “buying power” area indicates an area in which the load 12 is supplied with power from the power grid 6, the “selling power” area indicates an area in which a reverse flow is performed based on the power generated by the solar cell 1, “charging” indicates an area in which the storage battery 4 is charged based on the power from the power grid 6, and “discharging” indicates an area in which the storage battery 4 is discharged.

As illustrated in FIG. 2(a), in the first time period (from 23:00 to 7:00) which is a time period of the lowest rate, the charging and discharging control unit 10 performs control so as to convert alternating-current power from the power grid 6 into direct-current power by using the DC/AC inverter 7, convert the direct voltage by using the DC/DC converter 5, and charge the storage battery 4. Thus, the first time period corresponds to the “buying power” and “charging” areas.

Based on previously obtained meteorological information or meteorological information obtained in real time, the controller 11 transmits an instruction signal to the charging and discharging control unit 10 to determine the discharge starting time of the storage battery 4. Here, when it is assumed that the weather is forecast to be “sunny,” a sufficient amount of generated power is obtained by the solar cell 1 during the daytime (in particular, the third time period which is a time period of the highest rate), and therefore, in order to start discharging the storage battery 4 from 7:00 of the second time period, the controller 11 transmits an instruction signal to set the discharge starting time of the storage battery 4 controlled by the charging and discharging control unit 10 to 7:00 of the second time period. Therefore, the instruction signal from the controller 11 to the charging and discharging control unit 10 may be transmitted by 7:00 of the second time period.

In this way, when the time reaches 7:00 of the second time period, the load 12 is supplied with power from the storage battery 4. Note that as soon as it becomes possible to perform a reverse flow of power generated by the solar cell 1 depending on the sunrise time, or the like, the reverse flow is started.

According to the control operation illustrated in FIG. 2(a), the power generated by the solar cell 1 is available from 7:00, and the power from the storage battery 4 and the power from the solar cell 1 are supplied to the load 12.

Thereafter, basically, when the amount of power generated by the solar cell 1 increases and exceeds the amount of power self-consumed by the load 12, surplus power reversely flows to the power grid 6. Here, in a case where a so-called “push-up effect” of the storage battery is used, the power from the storage battery 4 in preference to the power from the solar cell 1 is supplied to the load 12, and if the amount of power from the storage battery 4 is larger than the amount of power self-consumed by the load 12, a reverse flow of all of the power from the solar cell 1 is performed. On the other hand, in a case where the “push-up effect” of the storage battery is not used, the storage battery 4 is not discharged during the reverse flow of the power from the solar cell 1 to the power grid, and the storage battery 4 is discharged in a time period, for example, in the nighttime period during which the solar cell 1 cannot generate power to such an extent that reverse flow is possible.

FIG. 2(a) shows that “selling power” (a reverse flow) is started when the amount of power of the “amount of generated power” exceeds the amount of power of the “self-consumption” after about 9:00.

Thereafter, basically, while the amount of power generated by the solar cell 1 is larger than the amount of power self-consumed by the load 12, surplus power reversely flows to the power grid 6, and when the amount of power generated by the solar cell 1 decreases below the amount of power self-consumed by the load 12, reverse flow is stopped.

FIG. 2(a) shows that the amount of power of the “self-consumption” exceeds the amount of power of the “amount of generated power” at a time after about 16:00. In the case where the “push-up effect” of the storage battery is not used, the storage battery 4 is not discharged during the reverse flow of the power from the solar cell 1 to the power grid, and therefore, “selling power” (a reverse flow) may be stopped at this time to start the discharging of the storage battery 4.

Thereafter, after the discharging of the storage battery 4 has been completed, the charging and discharging control unit 10 performs control so as to supply power supplied from the power grid 6 to the load 12 and so as to further charge the storage battery 4 with the power supplied from the power grid 6 at 23:00 of the first time period.

FIG. 2(a) shows that “buying power” is started on completion of “discharging” after about 20:00, and “charging” is started at 23:00 of the first time period.

As described above, on a day on which the weather is forecast to be sunny, a sufficient amount of power generated by the solar cell 1 is obtained in the third time period of the highest rate, and therefore, power which has been charged in the storage battery 4 in the first time period of the lowest rate starts to be discharged before the third time period, thereby reducing the power consumption rate. In the above description, the discharge starting time of the storage battery 4 is in the second time period (at 7:00), but as long as the storage battery 4 is sufficiently charged, the discharge starting time of the storage battery 4 may be set to the first time period prior to the second time period.

### (Description of the Case of Rainy Weather)

Next, the operation of the present embodiment on a day on which the weather is forecast to be rainy will be described with reference to FIG. 2(b).

As illustrated in FIG. 2(b), in the first time period (from 23:00 to 7:00) which is a time period of the lowest rate, the charging and discharging control unit 10 performs control so as to convert alternating-current power from the power grid 6 into direct-current power by using the DC/AC inverter 7, convert the direct voltage by using the DC/DC converter 5, and charge the storage battery 4. Thus, the first time period corresponds to the “buying power” and “charging” areas. This operation is the same as that in (Description of the Case of Sunny Weather) above.

Based on previously obtained meteorological information or meteorological information obtained in real time, the controller 11 transmits an instruction signal to the charging and discharging control unit 10 to determine the discharge starting time of the storage battery 4. Here, when it is assumed that the weather is forecast to be “rainy,” the amount of power generated by the solar cell 1 is insufficient during the daytime (in particular, the third time period which is a time period of the highest rate), and therefore, in order to start discharging the storage battery 4 from 10:00 of the third time period, the controller 11 transmits an instruction signal to set the discharge starting time of the storage battery 4 controlled by the charging and discharging control unit 10 to 10:00 of the third time period. Therefore, the instruction signal from the controller 11 to the charging and discharging control unit 10 may be transmitted by 10:00 of the third time period. Here, it is assumed that the meteorological information (weather forecast) was not changed before 7:00 to 10:00.

Therefore, in the case of rainy weather, since the storage battery 4 is not discharged even when the time reaches 7:00 of the second time period, power from the power grid 6 is continuously supplied to the load 12. Here, due to the rainy weather, in a case where the “push-up effect” of the storage battery is not used on this day, it is assumed that a reverse flow of power generated by the solar cell 1 is possible.

According to the control operation illustrated in FIG. 2(b), the power generated by the solar cell 1 is available after about 7:00. However, since the amount of power generated is insufficient, the amount of power supplied from the solar cell 1 to the load 12 is small. Therefore, power supplied from the power grid 6 is mainly consumed by the load 12.

Thereafter, at 10:00 of the third time period which is a time period of the highest rate, the charging and discharging control unit 10 performs control so as to discharge the storage battery 4 based on the instruction signal from the controller 11. This control stops supply of power from the power grid 6 to the load 12, and therefore, the load 12 is supplied with power from the storage battery 4 and power from the solar cell 1.

FIG. 2(b) shows that “discharging” is started and “buying power” is stopped at 10:00.

Thereafter, in the case where the “push-up effect” of the storage battery is not used, only power discharged from the storage battery 4 is supplied to the load 12 when power generated by the solar cell 1 decreases and can no longer be available.

FIG. 2(b) shows that shortly after 17:00, the “amount of generated power” is reduced to zero, and then, only “discharging” occurs.

Thereafter, after the discharging of the storage battery 4 has been completed, the charging and discharging control unit 10 performs control so as to supply power supplied from the power grid 6 to the load 12 and so as to further charge the storage battery 4 with the power supplied from the power grid 6 at 23:00 of the first time period.

FIG. 2(b) shows that “buying power” is started on completion of “discharging” at about 18:00, and “charging” is started at 23:00 of the first time period.

As described above, on a day on which the weather is forecast to be rainy, since the amount of power generated by the solar cell 1 is insufficient, power which has been charged in the storage battery 4 in the first time period of the lowest rate is efficiently discharged in the third time period of the highest rate, thereby reducing the power consumption rate. In the above description, the discharge starting time of the storage battery 4 is in the third time period, but as long as the rate can be sufficiently reduced, the discharge starting time of the storage battery 4 may be set to the second time period directly before the third time period.

While examples of the case where the weather is forecast to be “sunny” and the case where the weather is forecast to be “rainy” have been described above, the operation in (Description of the Case of Sunny Weather) or (Description of the Case of Rainy Weather) can basically be applicable to other cases where, for example, the weather is forecast to be “cloudy” by taking the power generation capability of the solar cell 1, the power storage capability (capacity) of the storage battery 4, the balance of the amount of power consumption by the load 12, and the like into consideration, and the charging and discharging control unit 10 may be configured such that a user can manually set the operation accordingly by using the controller 11. Moreover, the most important time period for the weather used as a criterion for decision is the third time period of the highest rate and the daytime during which the power generation capability of the solar cell 1 is enhanced in the case of sunny weather, and thus, for example, the control may be performed based on the weather forecast from 10:00 to 14:00.

According to the present embodiment, in the case where, with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, to which of the first to third time periods a discharge starting time of the storage battery is set is controlled based on meteorological information, thereby obtaining the effect of reducing the power consumption rate.

In the present embodiment, the above description has been given with reference to an example in which based on the power generation capability of the solar cell 1, the power storage capability (capacity) of the storage battery 4, and the balance of the amount of power consumption by the load 12, the discharging of the storage battery 4 is started in an early term of the second time period (for example, at 7:00) and is finished in a later term of the second time period (for example, after 20:00) in the case of sunny weather, and the discharging of the storage battery 4 is started in the third time period (for example, at 10:00) and is finished in the later term of the second time period (for example, after 17:00) in the case of rainy weather. Especially in such a case, the power consumption rate can be effectively reduced. However, the power consumption rate can sufficiently be reduced not only in such a case but also in a case where, for example, the discharging of the storage battery 4 is started in the early term of the second time period (for example, at 7:00) and is finished in the later term of the second time period (for example, at 19:00) in the case of sunny weather, and the discharging of the storage battery 4 is started in the third time period (for example, at 10:00) and is finished in the third time period (for example, at 16:00) in the case of rainy weather (the case where the completion time of the discharging of the storage battery 4 is in the third time period).

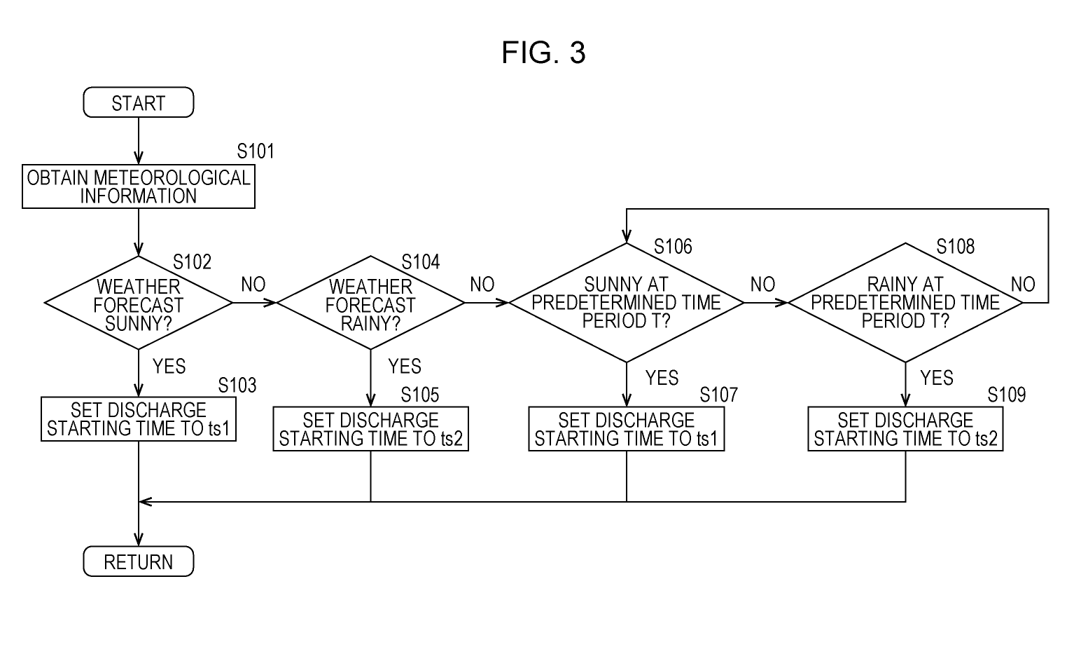

FIG. 3 is a flowchart illustrating the sequence of processes performed by the charging and discharging control unit 10.

### (Discharge Starting Time Determining Process)

First, meteorological information (a weather forecast) is obtained (S101; S means step, the same applies to the following description). If the obtained weather forecast is sunny, the storage and discharge starting time is set to a first discharge starting time ts1 (S103). If the weather forecast is rainy, the discharge starting time is set to a second discharge starting time ts2 (ts2 is later than ts1) (S103). Here, the discharge starting time is a time at which the discharging of the storage battery 4 is started. In the above-described example, ts1 is 7:00 and ts2 is 10:00.

When it is not possible to determine whether the weather is forecast to be sunny or rainy, it is determined whether or not the weather is forecast to be sunny in a predetermined time period T (S106). Here, the predetermined time T may be, for example, the third time period of the highest rate, from 10:00 to 17:00. When it is not possible to determine whether the weather is forecast to be sunny or rainy in the third time period, the predetermined time period T may be from 10:00 to 14:00 which is a time period in which the power generation capability of the solar cell 1 is further enhanced in the case of sunny weather. If the weather is forecast to be sunny, the discharge starting time is set to ts1 (S107). If the weather is forecast to be rainy at the predetermined time T, the discharge starting time is set to ts2 (S109).

### Second Embodiment

In the first embodiment, it has been described that the discharge starting time of the storage battery 4 is determined based on the meteorological information by 7:00 in (Description of the Case of Sunny Weather) and based on the meteorological information by 7:00 and the meteorological information by 10:00 in (Description of the Case of Rainy Weather). However, the meteorological information (weather forecast) may be changed at a later time. Therefore, in the second embodiment, a case where the meteorological information is changed after 7:00 in (Description of the Case of Sunny Weather) of the first embodiment will be described, and in the third embodiment which will be described later, a case where the meteorological information is changed after 7:00 in (Description of the Case of Rainy Weather) of the first embodiment will be described.

In the present embodiment, only the difference from (Description of the Case of Sunny Weather) of the first embodiment will be described. Processes until the time reaches 7:00 of the second time period and the load 12 is supplied with power from the storage battery 4 are the same as those in (Description of the Case of Sunny Weather) of the first embodiment.

Thereafter, the controller 11 externally obtains meteorological information via an Internet connection, or the like. Then, if the meteorological information is not changed by 10:00, operation similar to that in (Description of the Case of Sunny Weather) of the first embodiment is performed, but here, it is assumed that the meteorological information has been changed and thus the weather forecast has been changed to rainy. Note that the meteorological information can be obtained by the controller 11 regularly, for example, every 30 minutes or every 1 hour, or irregularly.

If it is assumed that the weather forecast has been changed to rainy based on the obtained meteorological information, the amount of power generated by the solar cell 1 during the daytime (in particular, the third time period which is a time period of the highest rate) is insufficient, and therefore, the controller 11 transmits an instruction signal to the charging and discharging control unit 10 to stop the discharging of the storage battery 4, which has once started to be discharged. Then, in order to start discharging the storage battery 4 from 10:00 of the third time period, the controller 11 transmits an instruction signal to set the discharge starting time of the storage battery 4 controlled by the charging and discharging control unit 10 to 10:00 of the third time period. Therefore, the instruction signal, which relates to the discharge starting time of the storage battery 4, is transmitted from the controller 11 to the charging and discharging control unit 10 by 10:00 of the third time period.

The operation after this step is similar to that in (Description of the Case of Rainy Weather) of the first embodiment. Note that when the controller 11 further obtains changed meteorological information (a changed weather forecast), operation similar to that of the third embodiment which will be described later is to be performed.

According to the present embodiment, it is possible to provide the effect of more optimally reducing the power consumption rate in the case where the meteorological information (weather forecast) has been changed in addition to the effect obtained by the first embodiment.

### Third Embodiment

In the third embodiment, a case where the meteorological information (weather forecast) is changed at a later time as in the second embodiment will be described. However, unlike the second embodiment, a case where the meteorological information has been changed after 7:00 in (Description of the Case of Rainy Weather) of the first embodiment will be described.

In the third embodiment, only the difference from (Description of the Case of Rainy Weather) of the first embodiment will be described. In (Description of the Case of Rainy Weather) of the first embodiment, it is assumed that the meteorological information has not been changed before 7:00 to 10:00. However, in the present embodiment, a case will be described in which the weather was forecast to be rainy according to the meteorological information before 7:00 but the weather forecast has been changed to sunny according to the meteorological information after 7:00.

Processes until the time passes about 7:00 and power supplied from the power grid 6 is mainly consumed by the load 12 without starting the discharging of the storage battery 4 are the same as those in (Description of the Case of Rainy Weather) of the first embodiment.

Thereafter, the controller 11 externally obtains meteorological information via an Internet connection, or the like. Then, if the meteorological information is not changed by 10:00, operation similar to that in (Description of the Case of Rainy Weather) of the first embodiment is performed, but here, it is assumed that the meteorological information has been changed and thus the weather forecast has been changed to sunny. Note that the meteorological information can be obtained by the controller 11 regularly, for example, every 30 minutes or every 1 hour, or irregularly as in the second embodiment.

If it is assumed that the weather forecast has been changed to sunny based on the obtained meteorological information, a sufficient amount of generated power is obtained by the solar cell 1 during the daytime (in particular, the third time period which is a time period of the highest rate), and therefore, the controller 11 transmits an instruction signal to immediately start the discharging of the storage battery 4, and the discharging of the storage battery 4 is started by being controlled by the charging and discharging control unit 10.

The operation after this step is similar to that in (Description of the Case of Sunny Weather) of the first embodiment. Note that when the controller 11 further obtains changed meteorological information (a changed weather forecast), operation similar to that of the second embodiment which has been described above is to be performed.

According to the present embodiment, it is possible to provide the effect of more optimally reducing the power consumption rate in the case where the meteorological information (weather forecast) has been changed in addition to the effect obtained by the first embodiment.

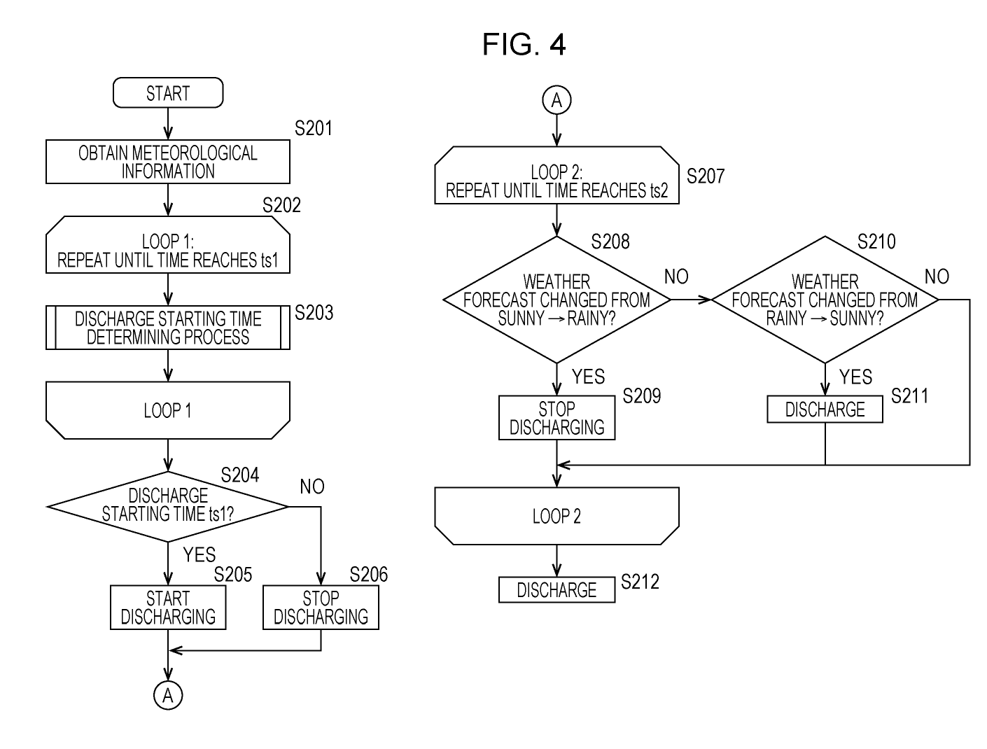

FIG. 4 is a flowchart illustrating the sequence of processes performed by the charging and discharging control unit 10 of the second embodiment and the third embodiment.

First, based on the obtained meteorological information (weather forecast), the discharge starting time determining process is performed until the current time reaches ts1 (S201-S203). When the current time has reached ts1, it is determined whether or not the discharge starting time is set to ts1 (S204), and if the discharge starting time is set to ts1, the discharging of the storage battery 4 is started (S205), but if the discharge starting time is not set to ts1, the storage battery 4 is not discharged (S206). Subsequently, processes of next steps S208-S210 are continuously performed in a time period in which the current time proceeds from ts1 to ts2 (S207). If the weather forecast has been changed from sunny to rainy (S208), the discharging of the storage battery 4 is stopped (S209), but if the weather forecast has been changed from rainy to sunny (S210), the discharging of the storage battery 4 is performed (S211). Then, after the time ts2, the discharging of the storage battery 4 is continued (S212).

### Fourth Embodiment

In the first to third embodiments, basically, an example in which the discharge starting time of the storage battery 4 can previously be set in the charging and discharging control unit 10 has been described, whereas in the fourth embodiment, an example in which the charging and discharging control unit 10 performs control so as to start the discharging of the storage battery 4 upon receiving an instruction signal from the controller 11 will be described.

First, in the first time period (from 23:00 to 7:00) which is a time period of the lowest rate, the charging and discharging control unit 10 performs control so as to convert alternating-current power from the power grid 6 into direct-current power by using the DC/AC inverter 7, convert the direct voltage by using the DC/DC converter 5, and charge the storage battery 4 as in the first embodiment.

If the weather is forecast to be “sunny” based on meteorological information previously obtained at a time before 7:00 or meteorological information obtained in real time, the controller 11 transmits an instruction signal to start discharging the storage battery 4 at 7:00 or at a time after 7:00 of the second time period, and the discharging of the storage battery 4 is started by being controlled by the charging and discharging control unit 10.

Thereafter, the controller 11 externally obtains meteorological information via an Internet connection, or the like regularly (for example, every 30 minutes, every 1 hour, etc.) or irregularly. If the weather forecast remains sunny and is not changed, the controller 11 does not transmit an instruction signal to the charging and discharging control unit 10 to stop the discharging of the storage battery 4, but if the weather forecast has been changed to rainy, the controller 11 transmits an instruction signal to the charging and discharging control unit 10 to stop the discharging of the storage battery 4. When the charging and discharging control unit 10 receives the instruction signal from the controller 11 to stop the discharging of the storage battery 4, the charging and discharging control unit 10 stops the discharging of the storage battery 4. The sequence of operation is accordingly repeated, and if the storage battery 4 is not discharged at a time immediately before 10:00, the controller 11 transmits an instruction signal to start discharging the storage battery 4 at 10:00 or at a time after 10:00 of the third time period, and the discharging of the storage battery 4 is started by being controlled by the charging and discharging control unit 10.

In contrast, if the weather is forecast to be “rainy” based on meteorological information previously obtained at a time before 7:00 or meteorological information obtained in real time, the controller 11 does not transmit an instruction signal to the charging and discharging control unit 10 to start the discharging of the storage battery 4 even at 7:00 or after 7:00 of the second time period.

Thereafter, the controller 11 externally obtains meteorological information via an Internet connection, or the like regularly (for example, every 30 minutes, every 1 hour, etc.) or irregularly. If the weather forecast remains rainy and is not changed, the controller 11 does not transmit an instruction signal to the charging and discharging control unit 10 to start the discharging of the storage battery 4, but if the weather forecast has been changed to sunny, the controller 11 transmits an instruction signal to the charging and discharging control unit 10 to start the discharging of the storage battery 4. When the charging and discharging control unit 10 receives the instruction signal from the controller 11 to start the discharging of the storage battery 4, the charging and discharging control unit 10 starts the discharging of the storage battery 4. The sequence of operation is accordingly repeated, and if the storage battery 4 is not discharged at a time immediately before 10:00, the controller 11 transmits an instruction signal to start discharging the storage battery 4 at 10:00 or at a time after 10:00 of the third time period, and the discharging of the storage battery 4 is started by being controlled by the charging and discharging control unit 10.

The operation other than these steps is similar to that of the first to third embodiments.

According to the present embodiment, it is possible to provide the effect of more optimally reducing the power consumption rate in the case where the meteorological information (weather forecast) has been changed in addition to the effect obtained by the first embodiment.

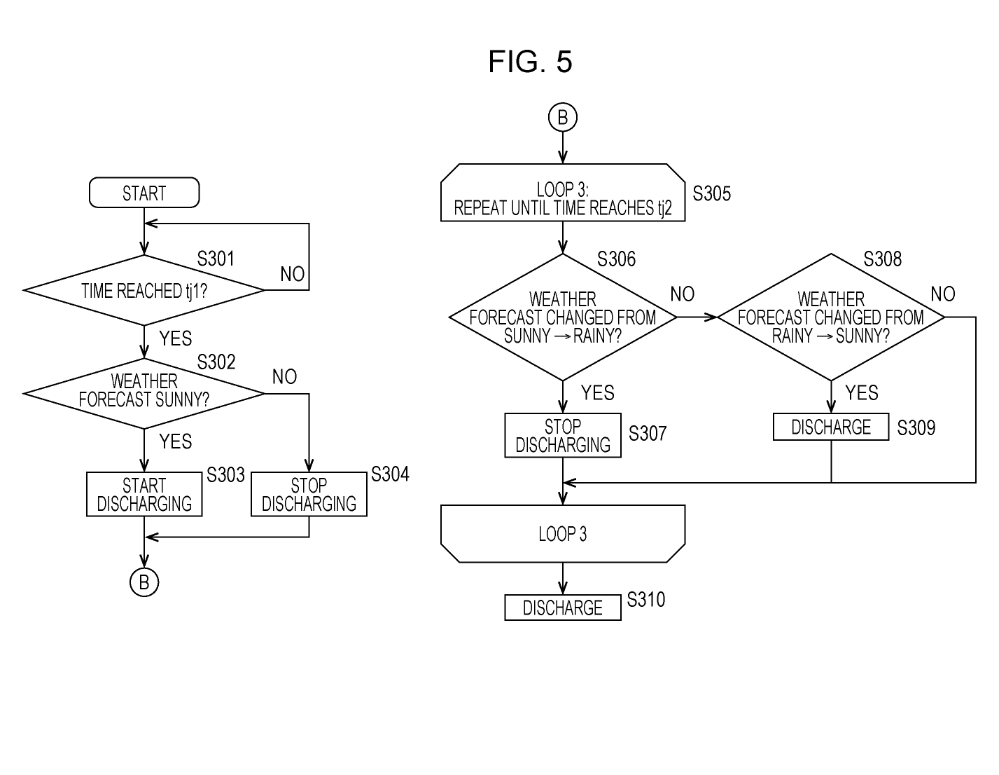

FIG. 5 is a flowchart illustrating the sequence of processes performed by the charging and discharging control unit 10 of the fourth embodiment.

Times at which it is determined whether or not the storage battery 4 can be discharged are a first discharge permission/inhibition determination time tj1 and a second discharge permission/inhibition determination time tj2, where tj2 is later than tj1. When the current time reaches tj1, the weather forecast is checked (S302). If the weather is forecast to be sunny, the storage battery 4 is discharged (S303), and if the weather is forecast to be rainy, the storage battery 4 is not discharged (S304). Subsequently, processes of next steps S306-S309 are continuously performed in a time period in which the current time proceeds from tj1 to tj2 (S305). If the weather forecast has been changed from sunny to rainy (S306), the discharging of the storage battery 4 is stopped (S307), but if the weather forecast has been changed from rainy to sunny (S308), the discharging of the storage battery 4 is performed (S309). Then, after the time tj2, the discharging of the storage battery 4 is continued (S310).

Note that the number of set discharge permission/inhibition determination times may be one, and in this case, discharge permission/inhibition determination is performed at a predetermined time, and a result of the determination is not changed thereafter.

In the first to fourth embodiments, examples in which the weather forecast is used as meteorological information have been described. However, any information such as insolation forecast can be used as long as the information predicts a meteorological phenomenon influencing the amount of power generated by the solar cell.

It should be understood that the embodiments disclosed herein have been described for the purpose of illustration only and in a non-restrictive manner in any respect. The scope of the present invention is defined by the terms of the claims, rather than the description above, and is intended to include any modifications within the meaning and scope equivalent to the terms of the claims.

### REFERENCE SIGNS LIST

1 Solar Cell
2 Generated Power Measurement Unit
3 DC/DC Converter
4 Storage Battery
5 DC/DC Converter
6 Power Grid
7 DC/AC Inverter
8 Selling Power Measurement Unit
9 Buying Power Measurement Unit
10 Charging and Discharging Control Unit
11 Controller
12 Load

1. A power system comprising:
a solar cell capable of performing a reverse flow of generated power to a power grid and capable of supplying generated power to a load;
a storage battery capable of being charged with power supplied from the power grid and capable of discharging the charged power to supply the discharged power to the load; and
a charging and discharging control device configured to control charging and discharging of the storage battery, wherein
with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and
the charging and discharging control device controls, based on meteorological information, to which of the time periods a discharge starting time of the storage battery is set.

2. The power system of claim 1, wherein
the meteorological information is at least one of weather forecast, precipitation, air temperature, humidity, wind direction, wind speed, insolation, duration of sunshine, sunrise and sunset times, weather warning, and weather advisory warning.

3. The power system of claim 2, wherein
the meteorological information is the weather forecast,
the charging and discharging control device controls the discharge starting time by performing a discharge starting time determining process, and
in the discharge starting time determining process, the discharge starting time is set to a first discharge starting time in a case where the weather forecast is sunny and to a second discharge starting time in a case where the weather forecast is rainy.

4. The power system of claim 3, wherein
the charging and discharging control device performs the discharge starting time determining process until the second discharge starting time elapses.

5. The power system of claim 2, wherein
the meteorological information is the weather forecast,
the charging and discharging control device controls the discharge starting time by performing a discharge permission/inhibition determination process, and
in the discharge permission/inhibition determination process, the discharging of the storage battery is started at a first discharge permission/inhibition determination time in a case where the weather forecast is sunny and at a predetermined time later than the first discharge permission/inhibition determination time in a case where the weather forecast is rainy.

6. The power system of claim 5, wherein
the charging and discharging control device performs the discharge permission/inhibition determination process until a second discharge permission/inhibition determination time later than the first discharge permission/inhibition determination time elapses.

7. A charging and discharging control device configured to control charging and discharging of a storage battery capable of being charged with power supplied from the power grid and capable of discharging the charged power to supply the discharged power to the load, wherein
with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and
the charging and discharging control device controls, based on meteorological information, to which of the time periods a discharge starting time of the storage battery is set.

8. The charging and discharging control device of claim 7, wherein
the meteorological information is at least one of weather forecast, precipitation, air temperature, humidity, wind direction, wind speed, insolation, duration of sunshine, sunrise and sunset times, weather warning, and weather advisory warning.

9. The charging and discharging control device of claim 8, wherein
the meteorological information is the weather forecast,
the charging and discharging control device controls the discharge starting time by performing a discharge starting time determining process, and
in the discharge starting time determining process, the discharge starting time is set to a first discharge starting time in a case where the weather forecast is sunny and to a second discharge starting time in a case where the weather forecast is rainy.

10. The charging and discharging control device of claim 9, wherein
the charging and discharging control device performs the discharge starting time determining process until the second discharge starting time elapses.

11. The charging and discharging control device of claim 8, wherein
the meteorological information is the weather forecast,
the charging and discharging control device controls the discharge starting time by performing a discharge permission/inhibition determination process, and
in the discharge permission/inhibition determination process, the discharging of the storage battery is started at a first discharge permission/inhibition determination time in a case where the weather forecast is sunny and at a predetermined time later than the first discharge permission/inhibition determination time in a case where the weather forecast is rainy.

12. The charging and discharging control device of claim 9, wherein
the charging and discharging control device performs the discharge permission/inhibition determination process until a second discharge permission/inhibition determination time later than the first discharge permission/inhibition determination time elapses.

13. A charging and discharging control method comprising:
controlling charging and discharging of a storage battery capable of being charged with power supplied from the power grid and capable of discharging the charged power to supply the discharged power to the load, wherein
with respect to usage of power supplied from the power grid, at least three time periods for rates, that is, a first time period, a second time period in which the rate is determined to be higher than that of the first time period, and a third time period in which the rate is determined to be higher than that of the second time period, are defined in this time sequence, and
to which of the time periods a discharge starting time of the storage battery is set is controlled based on meteorological information.

14. The charging and discharging control method of claim 13, wherein
the meteorological information is at least one of weather forecast, precipitation, air temperature, humidity, wind direction, wind speed, insolation, duration of sunshine, sunrise and sunset times, weather warning, and weather advisory warning.

15. The charging and discharging control method of claim 14, wherein
the meteorological information is the weather forecast,
the charging and discharging control device controls the discharge starting time by performing a discharge starting time determining process, and
in the discharge starting time determining process, the discharge starting time is set to a first discharge starting time in a case where the weather forecast is sunny and to a second discharge starting time in a case where the weather forecast is rainy.

16. The charging and discharging control method of claim 15, wherein
the charging and discharging control device performs the discharge starting time determining process until the second discharge starting time elapses.

17. The charging and discharging control method of claim 14, wherein
the meteorological information is the weather forecast,
the charging and discharging control device controls the discharge starting time by performing a discharge permission/inhibition determination process, and
in the discharge permission/inhibition determination process, the discharging of the storage battery is started at a first discharge permission/inhibition determination time in a case where the weather forecast is sunny and at a predetermined time later than the first discharge permission/inhibition determination time in a case where the weather forecast is rainy.

18. The charging and discharging control method of claim 15, wherein
the charging and discharging control device performs the discharge permission/inhibition determination process until a second discharge permission/inhibition determination time later than the first discharge permission/inhibition determination time elapses.
